(19) United States
(12) Patent Application Publication
(10) Pub. No.: US 2023/0410404 A1
(43) Pub. Date: Dec. 21, 2023

(54) THREE DIMENSIONAL OBJECT RECONSTRUCTION FOR SENSOR SIMULATION

(71) Applicant: WAABI Innovation Inc., Toronto (CA)

(72) Inventors: Ioan Andrei Barsan, Toronto (CA); Yun Chen, Toronto (CA); Wei-Chiu Ma, Toronto (CA); Sivabalan Manivasagam, Toronto (CA); Raquel Urtasun, Toronto (CA); Jingkang Wang, Toronto (CA); Ze Yang, Toronto (CA)

(73) Assignee: WAABI Innovation Inc., Toronto, ON (CA)

(21) Appl. No.: 18/209,609

(22) Filed: Jun. 14, 2023

Related U.S. Application Data
(60) Provisional application No. 63/352,616, filed on Jun. 15, 2022.

(51) Int. Cl. G06T 15/00; G06T 15/04

(52) U.S. Cl. CPC G06T 15/005; G06T 15/04

(57) ABSTRACT

Three dimensional object reconstruction for sensor simulation includes performing operations that include rendering, by a differential rendering engine, an object image from a target object model, and computing, by a loss function of the differential rendering engine, a loss based on a comparison of the object image with an actual image and a comparison of the target object model with a corresponding lidar point cloud. The operations further include updating the target object model by the differential rendering engine according to the loss, and rendering, after updating the target object model, a target object in a virtual world using the target object model.

### CROSS-REFERENCE TO RELATED APPLICATIONS

This application is a non-provisional application of, and therefore, claims benefit under 35 U.S.C. § 119(e) to, U.S. Patent Application Ser. No. 63/352,616, filed on Jun. 15, 2022, which is incorporated herein by reference in its entirety.

### BACKGROUND

A virtual world is a computer-simulated environment, which enable a player to interact in a three dimensional space as if the player were in the real world. In some cases, the virtual world is designed to replicate at least some aspects of the real world. For example, the virtual world may include one or more objects reconstructed from the real world. Reconstructing objects from the real world to represent in the virtual world brings realism, diversity and scale to virtual worlds.

In some cases, virtual objects are reconstructed from computer aided design (CAD) models. CAD models are often defined by humans and may be inaccurate so as to not reflect the real world objects. In such a scenario, the resulting virtual object generated by an erroneous CAD model does not match the real world.

### SUMMARY

In general, in one aspect, one or more embodiments relate to a method. The method includes rendering, by a differential rendering engine, an object image from a target object model, and computing, by a loss function of the differential rendering engine, a loss based on a comparison of the object image with an actual image and a comparison of the target object model with a corresponding lidar point cloud. The method further includes updating the target object model by the differential rendering engine according to the loss, and rendering, after updating the target object model, a target object in a virtual world using the target object model.

In general, in one aspect, one or more embodiments relate to a system that includes memory and at least one processor configured to execute instructions to perform operations. The operations include rendering, by a differential rendering engine, an object image from a target object model, and computing, by a loss function of the differential rendering engine, a loss based on a comparison of the object image with an actual image and a comparison of the target object model with a corresponding lidar point cloud. The operations further include updating the target object model by the differential rendering engine according to the loss, and rendering, after updating the target object model, a target object in a virtual world using the target object model.

In general, in one aspect, one or more embodiments relate to a non-transitory computer readable medium comprising computer readable program code for causing a computing system to perform operations. The operations include rendering, by a differential rendering engine, an object image from a target object model, and computing, by a loss function of the differential rendering engine, a loss based on a comparison of the object image with an actual image and a comparison of the target object model with a corresponding lidar point cloud. The operations further include updating the target object model by the differential rendering engine according to the loss, and rendering, after updating the target object model, a target object in a virtual world using the target object model.

Other aspects of the invention will be apparent from the following description and the appended claims.

### BRIEF DESCRIPTION OF DRAWINGS

FIG. 1 shows a diagram of an autonomous training and testing system in accordance with one or more embodiments.

FIG. 2 shows a flowchart of the autonomous training and testing system in accordance with one or more embodiments.

FIG. 3 shows a diagram of a rendering system in accordance with one or more embodiments.

FIG. 4 shows a flowchart for generating a decomposed object model in accordance with one or more embodiments.

FIG. 5 shows a flowchart for training an object model in accordance with one or more embodiments.

FIG. 6 shows a flowchart for calculating loss in accordance with one or more embodiments.

FIG. 7 shows an example diagram for virtual simulation in accordance with one or more embodiments.

FIG. 8 shows an example diagram showing a decomposed object model in accordance with one or more embodiments.

FIG. 9 shows an example diagram showing differential rendering in accordance with one or more embodiments.

FIGS. 10A and 10B show a computing system in accordance with one or more embodiments of the invention.

Like elements in the various figures are denoted by like reference numerals for consistency.

### DETAILED DESCRIPTION

In general, embodiments are directed to target object reconstruction in a virtual world by training a computer aided design (CAD) model to more accurately reflect the real world or actual object. Target object reconstruction is rendering a virtual version of a real world object in the virtual world. For a particular target object, one or more embodiments perform a differential rendering of the target object. The differential rendering process renders an object image from a target object model. Based on the object image, a loss is calculated, which is then used to update the target object model. The loss is based on a comparison of the object image with the actual image and a comparison of the target object model with a corresponding LiDAR point cloud. Through periodic updates, the target object model becomes more accurate. Thus, when the target object model is used to render the virtual object in a manner not observed in the real world, a more accurate virtual object is rendered.

The object reconstruction of the target object may be performed as part of generating a simulated environment in order to train and test an autonomous system. An autonomous system is a self-driving mode of transportation that does not require a human pilot or human driver to move and react to the real-world environment. Rather, the autonomous system includes a virtual driver that is the decision making portion of the autonomous system. The virtual driver is an artificial intelligence system that learns how to interact in the real world. The autonomous system may be completely autonomous or semi-autonomous. As a mode of transportation, the autonomous system is contained in a housing configured to move through a real-world environment. Examples of autonomous systems include self-driving vehicles (e.g., self-driving trucks and cars), drones, airplanes, robots, etc. The virtual driver is the software that makes decisions and causes the autonomous system to interact with the real-world including moving, signaling, and stopping or maintaining a current state.

The real world environment is the portion of the real world through which the autonomous system, when trained, is designed to move. Thus, the real world environment may include interactions with concrete and land, people, animals, other autonomous systems, and human driven systems, construction, and other objects as the autonomous system moves from an origin to a destination. In order to interact with the real-world environment, the autonomous system includes various types of sensors, such as LiDAR sensors amongst other types, which are used to obtain measurements of the real-world environment and cameras that capture images from the real world environment.

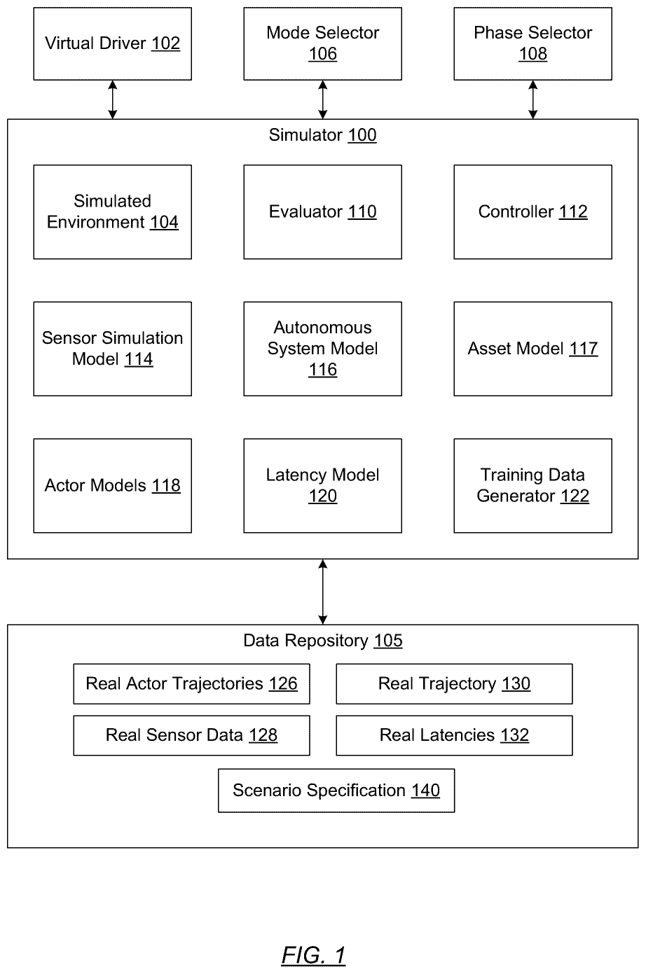

The testing and training of virtual driver of the autonomous systems in the real-world environment is unsafe because of the accidents that an untrained virtual driver can cause. Thus, as shown in FIG. 1, a simulator (100) is configured to train and test a virtual driver (102) of an autonomous system. For example, the simulator may be a unified, modular, mixed-reality, closed-loop simulator for autonomous systems. The simulator (100) is a configurable simulation framework that enables not only evaluation of different autonomy components in isolation, but also as a complete system in a closed-loop manner. The simulator reconstructs “digital twins” of real world scenarios automatically, enabling accurate evaluation of the virtual driver at scale. The simulator (100) may also be configured to perform mixed-reality simulation that combines real world data and simulated data to create diverse and realistic evaluation variations to provide insight into the virtual driver's performance. The mixed reality closed-loop simulation allows the simulator (100) to analyze the virtual driver's action on counterfactual “what-if” scenarios that did not occur in the real-world. The simulator (100) further includes functionality to simulate and train on rare yet safety-critical scenarios with respect to the entire autonomous system and closed-loop training to enable automatic and scalable improvement of autonomy.

The simulator (100) creates the simulated environment (104) that is a virtual world in which the virtual driver (102) is the player in the virtual world. The simulated environment (104) is a simulation of a real-world environment, which may or may not be in actual existence, in which the autonomous system is designed to move. As such, the simulated environment (104) includes a simulation of the objects (i.e., simulated objects or assets) and background in the real world, including the natural objects, construction, buildings and roads, obstacles, as well as other autonomous and non-autonomous objects. The simulated environment simulates the environmental conditions within which the autonomous system may be deployed. Additionally, the simulated environment (104) may be configured to simulate various weather conditions that may affect the inputs to the autonomous systems. The simulated objects may include both stationary and non-stationary objects. Non-stationary objects are actors in the real-world environment.

The simulator (100) also includes an evaluator (110). The evaluator (110) is configured to train and test the virtual driver (102) by creating various scenarios the simulated environment. Each scenario is a configuration of the simulated environment including, but not limited to, static portions, movement of simulated objects, actions of the simulated objects with each other and reactions to actions taken by the autonomous system and simulated objects. The evaluator (110) is further configured to evaluate the performance of the virtual driver using a variety of metrics.

The evaluator (110) assesses the performance of the virtual driver throughout the performance of the scenario. Assessing the performance may include applying rules. For example, the rules may be that the automated system does not collide with any other actor, compliance with safety and comfort standards (e.g., passengers not experiencing more than a certain acceleration force within the vehicle), the automated system not deviating from executed trajectory), or other rule. Each rule may be associated with the metric information that relates a degree of breaking the rule with a corresponding score. The evaluator (110) may be implemented as a data-driven neural network that learns to distinguish between good and bad driving behavior. The various metrics of the evaluation system may be leveraged to determine whether the automated system satisfies the requirements of success criterion for a particular scenario. Further, in addition to system level performance, for modular based virtual drivers, the evaluator may also evaluate individual modules such as segmentation or prediction performance for actors in the scene with respect to the ground truth recorded in the simulator.

The simulator (100) is configured to operate in multiple phases as selected by the phase selector (108) and modes as selected by a mode selector (106). The phase selector (108) and mode selector (106) may be a graphical user interface or application programming interface component that is configured to receive a selection of phase and mode, respectively. The selected phase and mode define the configuration of the simulator (100). Namely, the selected phase and mode define which system components communicate and the operations of the system components.

The phase may be selected using a phase selector (108). The phase may be training phase or testing phase. In the training phase, the evaluator (110) provides metric information to the virtual driver (102), which uses the metric information to update the virtual driver (102). The evaluator (110) may further use the metric information to further train the virtual driver (102) by generating scenarios for the virtual driver. In the testing phase, the evaluator (110) does not provide the metric information to the virtual driver. In the testing phase, the evaluator (110) uses the metric information to assess the virtual driver and to develop scenarios for the virtual driver (102).

The mode may be selected by the mode selector (106). The mode defines the degree to which real-world data is used, whether noise is injected into simulated data, degree of perturbations of real world data, and whether the scenarios are designed to be adversarial. Example modes include open loop simulation mode, closed loop simulation mode, single module closed loop simulation mode, fuzzy mode, and adversarial mode. In an open loop simulation mode, the virtual driver is evaluated with real world data. In a single module closed loop simulation mode, a single module of the virtual driver is tested. An example of a single module closed loop simulation mode is a localizer closed loop simulation mode in which the simulator evaluates how the localizer estimated pose drifts over time as the scenario progresses in simulation. In a training data simulation mode, simulator is used to generate training data. In a closed loop evaluation mode, the virtual driver and simulation system are executed together to evaluate system performance. In the adversarial mode, the actors are modified to perform adversarial. In the fuzzy mode, noise is injected into the scenario (e.g., to replicate signal processing noise and other types of noise). Other modes may exist without departing from the scope of the system.

The simulator (100) includes the controller (112) that includes functionality to configure the various components of the simulator (100) according to the selected mode and phase. Namely, the controller (112) may modify the configuration of the each of the components of the simulator based on configuration parameters of the simulator (100). Such components include the evaluator (110), the simulated environment (104), an autonomous system model (116), sensor simulation models (114), asset models (117), actor models (118), latency models (120), and a training data generator (122).

The autonomous system model (116) is a detailed model of the autonomous system in which the virtual driver will execute. The autonomous system model (116) includes model, geometry, physical parameters (e.g., mass distribution, points of significance), engine parameters, sensor locations and type, firing pattern of the sensors, information about the hardware on which the virtual driver executes (e.g., processor power, amount of memory, and other hardware information), and other information about the autonomous system. The various parameters of the autonomous system model may be configurable by the user or another system.

For example, if the autonomous system is a motor vehicle, the modeling and dynamics may include the type of vehicle (e.g., car, truck), make and model, geometry, physical parameters such as the mass distribution, axle positions, type and performance of engine, etc. The vehicle model may also include information about the sensors on the vehicle (e.g., camera, LiDAR, etc.), the sensors' relative firing synchronization pattern, and the sensors' calibrated extrinsics (e.g., position and orientation) and intrinsics (e.g., focal length). The vehicle model also defines the onboard computer hardware, sensor drivers, controllers, and the autonomy software release under test.

The autonomous system model includes an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment to update the simulated environment and the state of the autonomous system. To update the state, a kinematic motion model may be used, or a dynamics motion model that accounts for the forces applied to the vehicle may be used to determine the state. Within the simulator, with access to real log scenarios with ground truth actuations and vehicle states at each time step, embodiments may also optimize analytical vehicle model parameters or learn parameters of a neural network that infers the new state of the autonomous system given the virtual driver outputs.

In one or more embodiments, the sensor simulation models (114) models, in the simulated environment, active and passive sensor inputs. Passive sensor inputs capture the visual appearance of the simulated environment including stationary and nonstationary simulated objects from the perspective of one or more cameras based on the simulated position of the camera(s) within the simulated environment. Example of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, the measurements being simulated based on the simulated environment based on the simulated position of the sensor(s) within the simulated environment. By way of an example, the active sensor measurements may be measurements that a LiDAR sensor would make of the simulated environment over time and in relation to the movement of the autonomous system.

The sensor simulation models (114) are configured to simulates the sensor observations of the surrounding scene in the simulated environment (104) at each time step according to the sensor configuration on the vehicle platform. When the simulated environment directly represents the real world environment, without modification, the sensor output may be directly fed into the virtual driver. For light-based sensors, the sensor model simulates light as rays that interact with objects in the scene to generate the sensor data. Depending on the asset representation (e.g., of stationary and nonstationary objects), embodiments may use graphics-based rendering for assets with textured meshes, neural rendering, or a combination of multiple rendering schemes. Leveraging multiple rendering schemes enables customizable world building with improved realism. Because assets are compositional in 3D and support a standard interface of render commands, different asset representations may be composed in a seamless manner to generate the final sensor data. Additionally, for scenarios that replay what happened in a real world and use the same autonomous system as in the real world, the original sensor observations may be replayed at each time step.

Asset models (117) includes multiple models, each model modeling a particular type of individual assets in the real world. The assets may include inanimate objects such as construction barriers or traffic signs, parked cars, and background (e.g., vegetation or sky). Each of the entities in a scenario may correspond to an individual asset. As such, an asset model, or instance of a type of asset model, may exist for each of the entities or assets in the scenario. The assets can be composed together to form the three dimensional simulated environment. An asset model provides all the information needed by the simulator to simulate the asset. The asset model provides the information used by the simulator to represent and simulate the asset in the simulated environment. For example, an asset model may include geometry and bounding volume, the asset's interaction with light at various wavelengths of interest (e.g., visible for camera, infrared for LiDAR, microwave for RADAR), animation information describing deformation (e.g. rigging) or lighting changes (e.g., turn signals), material information such as friction for different surfaces, and metadata such as the asset's semantic class and key points of interest. Certain components of the asset may have different instantiations. For example, similar to rendering engines, an asset geometry may be defined in many ways, such as a mesh, voxels, point clouds, an analytical signed-distance function, or neural network. Asset models may be created either by artists, or reconstructed from real world sensor data, or optimized by an algorithm to be adversarial.

Closely related to, and possibly considered part of the set of asset models (117) are actor models (118). An actor model (118) represents an actor in a scenario. An actor is a sentient being that has an independent decision making process. Namely, in a real world, the actor may be animate being (e.g., person or animal) that makes a decision based on an environment. The actor makes active movement rather than or in addition to passive movement. An actor model, or an instance of an actor model may exist for each actor in a scenario. The actor model is a model of the actor. If the actor is in a mode of transportation, then the actor model includes the model of transportation in which the actor is located. For example, actor models may represent pedestrians, children, vehicles being driven by drivers, pets, bicycles, and other types of actors.

The actor model (118) leverages the scenario specification and assets to control all actors in the scene and their actions at each time step. The actor's behavior is modeled in a region of interest centered around the autonomous system. Depending on the scenario specification, the actor simulation will control the actors in the simulation to achieve the desired behavior. Actors can be controlled in various ways. One option is to leverage heuristic actor models, such as intelligent-driver model (IDM) that try to maintain a certain relative distance or time-to-collision (TTC) from a lead actor or heuristic-derived lane-change actor models. Another is to directly replay actor trajectories from a real log, or to control the actor(s) with a data-driven traffic model. Through the configurable design, embodiments may can mix and match different subsets of actors to be controlled by different behavior models. For example, far-away actors that initially may not interact with the autonomous system and can follow a real log trajectory, but when near the vicinity of the autonomous system may switch to a data-driven actor model. In another example, actors may be controlled by a heuristic or data-driven actor model that still conforms to the high-level route in a real-log. This mixed-reality simulation provides control and realism.

Further, actor models may be configured to be in cooperative or adversarial mode. In cooperative mode, the actor model models actors to act rationally in response to the state of the simulated environment. In adversarial mode, the actor model may model actors acting irrationally, such as exhibiting road rage and bad driving.

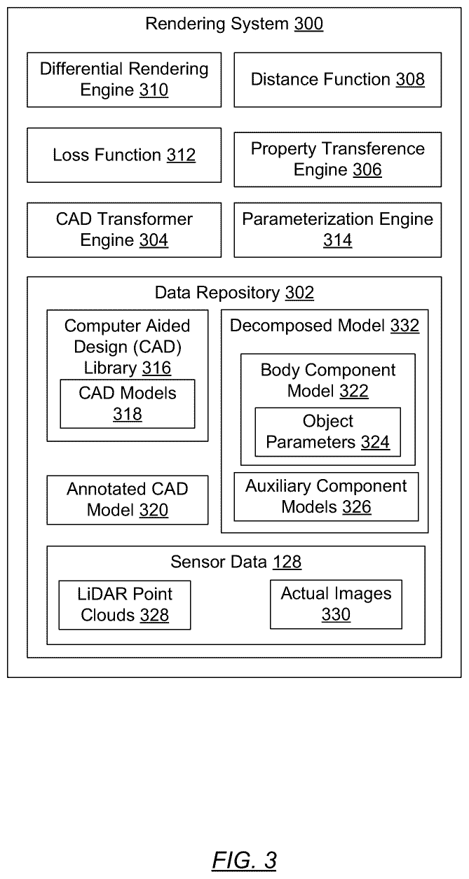

In one or more embodiments, all or a portion of the sensor simulation models (114), asset models (117), and/or actor models (118) may be or include the rendering system (300) shown in FIG. 3. In such a scenario, the rendering system (300) of the sensor simulation models (114), asset models (117), and/or actor models (118) may perform the operations of FIGS. 3-6. Specifically, the actors and assets may be the target objects described in FIGS. 3-6.

The latency model (120) represents timing latency that occurs when the autonomous system is in the real world environment. Several sources of timing latency may exist. For example, a latency may exist from the time that an event occurs to the sensors detecting the sensor information from the event and sending the sensor information to the virtual driver. Another latency may exist based on the difference between the computing hardware executing the virtual driver in the simulated environment as compared to the computing hardware of the virtual driver. Further, another timing latency may exist between the time that the virtual driver transmits an actuation signal to the autonomous system changing (e.g., direction or speed) based on the actuation signal. The latency model (120) models the various sources of timing latency.

Stated another way, in the real world, safety-critical decisions in the real world may involve fractions of a second affecting response time. The latency model simulates the exact timings and latency of different components of the onboard system. To enable scalable evaluation without strict requirement on exact hardware, the latencies and timings of the different components of autonomous system and sensor modules are modeled while running on different computer hardware. The latency model may replay latencies recorded from previously collected real world data or have a data-driven neural network that infers latencies at each time step to match the hardware in loop simulation setup.

The training data generator (122) is configured to generate training data. For example, the training data generator (122) may modify real-world scenarios to create new scenarios. The modification of real-world scenarios is referred to as mixed reality. For example, mixed-reality simulation may involve adding in new actors with novel behaviors, changing the behavior of one or more of the actors from the real-world, and modifying the sensor data in that region while keeping the remainder of the sensor data the same as the original log. In some cases, the training data generator (122) converts a benign scenario into a safety-critical scenario.

The simulator (100) is connected to a data repository (105). The data repository (105) is any type of storage unit or device that is configured to store data. The data repository (105) includes data gathered from the real world. For example, the data gathered from the real world include real actor trajectories (126), real sensor data (128), real trajectory of the system capturing the real world (130), and real latencies (132). Each of the real actor trajectories (126), real sensor data (128), real trajectory of the system capturing the real world (130), and real latencies (132) is data captured by or calculated directly from one or more sensors from the real world (e.g., in a real world log). In other words, the data gathered from the real-world are actual events that happened in real life. For example, in the case that the autonomous system is a vehicle, the real world data may be captured by a vehicle driving in the real world with sensor equipment.

Further, the data repository (105) includes functionality to store one or more scenario specifications (140). A scenario specification (140) specifies a scenario and evaluation setting for testing or training the autonomous system. For example, the scenario specification (140) may describe the initial state of the scene, such as the current state of autonomous system (e.g., the full 6D pose, velocity and acceleration), the map information specifying the road layout, and the scene layout specifying the initial state of all the dynamic actors and objects in the scenario. The scenario specification may also include dynamic actor information describing how the dynamic actors in the scenario should evolve over time which are inputs to the actor models. The dynamic actor information may include route information for the actors, desired behaviors or aggressiveness. The scenario specification (140) may be specified by a user, programmatically generated using a domain-specification-language (DSL), procedurally generated with heuristics from a data-driven algorithm, or adversarial. The scenario specification (140) can also be conditioned on data collected from a real world log, such as taking place on a specific real world map or having a subset of actors defined by their original locations and trajectories.

The interfaces between virtual driver and the simulator match the interfaces between the virtual driver and the autonomous system in the real world. For example, the sensor simulation model (114) and the virtual driver matches the virtual driver interacting with the sensors in the real world. The virtual driver is the actual autonomy software that executes on the autonomous system. The simulated sensor data that is output by the sensor simulation model (114) may be in or converted to the exact message format that the virtual driver takes as input as if the virtual driver were in the real world, and the virtual driver can then run as a black box virtual driver with the simulated latencies incorporated for components that run sequentially. The virtual driver then outputs the exact same control representation that it uses to interface with the low-level controller on the real autonomous system. The autonomous system model (116) will then update the state of the autonomous system in the simulated environment. Thus, the various simulation models of the simulator (100) run in parallel asynchronously at their own frequencies to match the real world setting.

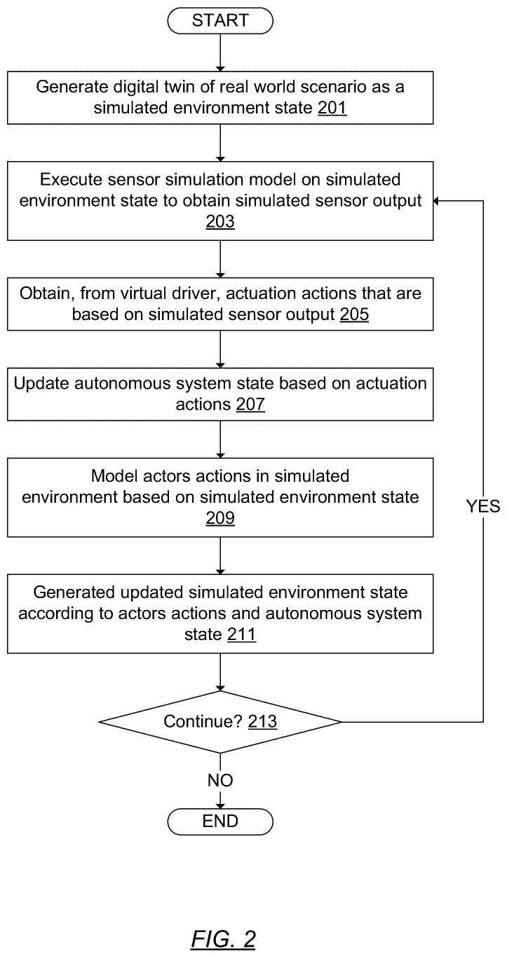

FIG. 2 shows a flow diagram for executing the simulator in a closed loop mode. In Block 201, a digital twin of a real world scenario is generated as a simulated environment state. Log data from the real world is used to generate an initial virtual world. The log data defines which asset and actor models are used in an initial positioning of assets. For example, using convolutional neural networks on the log data, the various asset types within the real world may be identified. As other examples, offline perception systems and human annotations of log data may be used to identify asset types. Accordingly, corresponding asset and actor modes may be identified based on the asset types and add to the positions of the real actors and assets in the real world. Thus, the asset and actor models to create an initial three dimensional virtual world.

In Block 203, the sensor simulation model is executed on the simulated environment state to obtain simulated sensor output. The sensor simulation model may use beamforming and other techniques to replicate the view to the sensors of the autonomous system. Each sensor of the autonomous system has a corresponding sensor simulation model and a corresponding system. The sensor simulation model executes based on the position of the sensor within the virtual environment and generates simulated sensor output. The simulated sensor output is in the same form as would be received from a real sensor by the virtual driver.

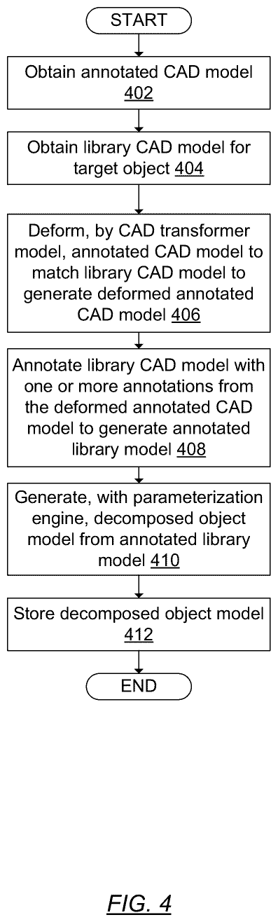

Generating assets and actors in the virtual world, and then generating simulated sensor input may be performed using a trained target object model, which is trained as described in FIGS. 4-6. After training the target object model, simulation may be performed to generate camera output and lidar sensor output, respectively, for a virtual camera and a virtual lidar sensor based on the relative location of the corresponding virtual sensor and target object in the virtual world. Location and viewing direction of the sensor with respect to the autonomous vehicle may be used to replicate originating location of the corresponding virtual sensor on the simulated autonomous system. Thus, the various sensor inputs to the virtual driver match the combination of inputs if the virtual driver were in the real world.

The simulated sensor output is passed to the virtual driver. In Block 205, the virtual drive executes based on the simulated sensor output to generate actuation actions. The actuation actions define how the virtual driver controls the autonomous system. For example, for an SDV, the actuation actions may be amount of acceleration, movement of the steering, triggering of a turn signal, etc. From the actuation actions, the autonomous system state in the simulated environment is updated in Block 207. The actuation actions are used as input to the autonomous system model to determine the actual actions of the autonomous system. For example, the autonomous system dynamic model may use the actuation actions in addition to road and weather conditions to represent the resulting movement of the autonomous system. For example, in a wet or snow environment, the same amount of acceleration action as in a dry environment may cause less acceleration than in the dry environment. As another example, the autonomous system model may account for possibly faulty tires (e.g., tire slippage), mechanical based latency, or other possible imperfections in the autonomous system.

In Block 209, actors' actions in the simulated environment are modeled based on the simulated environment state. Concurrently with the virtual driver model, the actor models and asset models are executed on the simulated environment state to determine an update for each of the assets and actors in the simulated environment. Here, the actors' actions may use the previous output of the evaluator to test the virtual driver. For example, if the actor is adversarial, the evaluator may indicate based on the previous action of the virtual driver, the lowest scoring metric of the virtual driver. Using a mapping of metrics to actions of the actor model, the actor model executes to exploit or test that particular metric.

Thus, in Block 211, the updated simulated environment state is updated according to the actors' actions and the autonomous system state. The updated simulated environment includes the change in positions of the actors and the autonomous system. Because the models execute independently of the real world, the update may reflect a deviation from the real world. Thus, the autonomous system is tested with new scenarios. In Block 213, a determination is made whether to continue. If the determination is made to continue, testing of the autonomous system continues using the updated simulated environment state in Block 203. At each iteration, during training, the evaluator provides feedback to the virtual driver. Thus, the parameters of the virtual driver are updated to improve performance of the virtual driver in a variety of scenarios. During testing, the evaluator is able to test using a variety of scenarios and patterns including edge cases that may be safety critical. Thus, one or more embodiments improve the virtual driver and increase safety of the virtual driver in the real world.

As shown, the virtual driver of the autonomous system acts based on the scenario and the current learned parameters of the virtual driver. The simulator obtains the actions of the autonomous system and provides a reaction in the simulated environment to the virtual driver of the autonomous system. The evaluator evaluates the performance of the virtual driver and creates scenarios based on the performance. The process may continue as the autonomous system operates in the simulated environment.

FIG. 3 shows a diagram of a rendering system (300) in accordance with one or more embodiments. As shown in FIG. 3, the rendering system (300) includes a data repository (302), a CAD transformer engine (304), a property transference engine (306), a distance function (308), a differential rendering engine (310), a loss function (312), and a parameterization engine (314). Each of these components is described below.

In one or more embodiments, the data repository (302) is any type of storage unit and/or device (e.g., a file system, database, data structure, or any other storage mechanism) for storing data. Further, the data repository (302) may include multiple different, potentially heterogeneous, storage units and/or devices.

The data repository (302) includes a CAD library (316) having CAD models (318), an annotated CAD model (320), a decomposed model (332) having a component model (322) with parameters (324) and auxiliary component models (324), and sensor data (128) that include LiDAR point clouds (328) and actual images (330). The data in the data repository (302) is described below.

The CAD library (316) is a library of CAD models (318). In one or more embodiments, the CAD library (316) is a third party library stored on a different physical storage unit than the remainder of the data repository or may be separate from the data repository and only accessed by the rendering system. The CAD library (316) may be for a particular category of object. For example, the CAD library may be for different types of vehicles (e.g., as defined by make and model of the vehicle or as defined by class of vehicle), by types of stationary objects, or other types of other transport modes.

A CAD model is a model of the type of object within the category of object. A type, when referring to type of object, is a group of objects which share common properties, of which individual objects of the type are instances of the type. In one or more embodiments, the CAD model includes multiple layers, a first layer is a geometry defining the shape of objects of the type, a second layer is a texture map describing texture of objects of the type, a third layer is a material property map defining material properties of objects of the type, and a fourth layer is a skeleton defining an interrelationships of parts of objects of the type. For the texture map and material property map, the disneyPBR material model may be used that includes three images: a diffuse color texture image (W×H×3), a normal map (W×H×3), and another material image (W×H×3). For each image, three channels contain roughness W×H×1, metal W×H×1, and another unused channel.

The skeleton defines how the parts of the model are connected, and the physically plausible range that the parts can move with respect to each other. For instance, vehicles have deformable parts including windows, wheels and doors and main body that has movement and connection reflected in the skeleton. For the motorcycles, the skeleton models the handlebar and main body. The CAD model (318) in the CAD library (316) may be defined using a mesh network. A layer in the mesh network is a set of vertices and faces. The vertices are real numeric values that specify a location in a three dimensional space. The faces define the connectivity of the vertices. In the CAD model (318) in the CAD library (316), the components of objects are part of a unitary whole. Namely, the components are not separately defined.

An annotated CAD model (320) is a CAD model that is annotated to demarcate the component parts that may be separate from each other. For example, the annotated CAD model may detail the boundary lines of wheels, the boundary lines of windows, mirrors, or doors. For example, the annotation may define which vertices and faces are part of a particular component. The annotated may be defined by the set of vertices that form the boundaries of a particular component. In one or more embodiment, the annotated CAD model (320) may be a human annotated model. CAD models in the CAD library may be automatically annotated to create annotated library models (not shown). An annotated library model is a CAD model from the CAD library (316) that is annotated by the computer.

A decomposed model (332) is a CAD model (318) that is decomposed into multiple CAD models (e.g., body component model (322), auxiliary component model (326)), each CAD model corresponding to a particular component of the object. In particular, each component model is an individual and distinct CAD model as described above, but for only a component of the overarching object. The component models may be separately stored from each other. The component models may each include the multiple layers (described above) and may each be defined by a mesh network.

The decomposed model (332) includes a body component model (322) and one or more auxiliary composed models (326). A body component model (322) is a CAD model of the body of an object of a particular type. The auxiliary component models (326) are CAD models of the auxiliary components of the object of the particular type. For example, the auxiliary component model (326) may be a model of a tires, window, side mirror, or other components of the object.

One or more of the component models (326) are generic component models to multiple types of objects. Generic means that the same component model may be referenced and used by multiple different body component models (322). For example, the same generic auxiliary component model (326) may be part of the decomposed model for an object of a first type and also part of the decomposed model for an object of a second type. Further, the same generic auxiliary component model may be referenced multiple times by the same body component model for different locations of the object. By way of a specific example, if the decomposed model is for a particular vehicle make and vehicle model of a vehicle, the body component model is for the particular vehicle make and vehicle model, the auxiliary component model may be for the tires of the vehicle. The same auxiliary component model may be used for different tires of the same vehicle type and for different vehicle types.

The body component model (322) includes a set of object parameters (324). The object parameters (324) define how the auxiliary component models (326) fit with the body component model (322). For example, the object parameters (324) may specify location parameters identifying one or more connection points on the body component model (322) to which the auxiliary component connects, scaling parameters that define an amount of scaling in one or more directions (e.g., along the x, y, z axis), and other parameters. By maintaining and storing separate auxiliary component models that may be generic across multiple body component models, one or more embodiments reduce the storage requirements for the data repository (302).

The data repository (302) also includes functionality to store sensor data (128). The sensor data (128) is real sensor data described above with reference to FIG. 1. Specifically, the sensor data (128) includes LiDAR point clouds (328) and actual images (330) generated or captured by physical (i.e., real) LiDAR sensors and real cameras, respectively, from the real world. Because the sensor data is actual data captured from the real world, the sensor data (128) is used to improve the accuracy of the object models (e.g., decomposed model, annotated library model).

The data repository (302) is connected to various other components of the rendering system (300). For example, the data repository (302) is connected to a CAD transformer engine (304). The CAD transformer engine (304) is software that has instructions to deform an annotated CAD model (320) to match a CAD model (318) defined for a different object type. For example, the CAD transformer engine (304) may deform various vertices of the mesh network of the annotated CAD model to align the vertices with corresponding vertices of the library CAD model. The CAD transformer engine (304) may be configured to perform stochastic gradient descent to perform the deformations. As another example, the CAD transformer engine (304) may be a machine learning model that uses the various layers of the CAD model to perform the deformations. For example, the CAD transformer engine (304) may include the reflectivity of the material properties layer to identify which vertices correspond to windows and which layers correspond to other parts of the object.

The property transference engine (306) is software that is configured to transfer one or more of the material properties or texture of a source object model to a target object model. The source object model is the object model (e.g., the annotated CAD model (320)) that is the source of the material properties from which the material properties are copied. The target object model is the target of the material properties to which the material properties are copied. For example, the material properties being transferred may be color, material shininess, material texture, etc. The property transference engine (306) transfers the properties based on matching faces between the source object model and the target object model.

The distance function (308) is a software function configured to determine whether the distances of the LiDAR point cloud (328) matches the corresponding distances of the corresponding object model. Specifically, the distance function (308) determines whether the distances between the vertices match the distances between corresponding points on the LiDAR point cloud (328). In one or more embodiments, the distance function (308) determines whether a virtual LiDAR sensor pointing at the target object model at the same location as the real LiDAR sensor that captures the LiDAR point cloud has the same distances as the matching points in the LiDAR point cloud.

In one or more embodiments, the distance function (308) captures Chamfer distance. Given a set of vertices from mesh A and vertices from mesh B, the chamfer distance computes the distance for the closest vertex in mesh B for every vertex in mesh A, and the distance for the closest vertex in mesh A for every vertex in mesh B, and then combines the distances together (either as a sum or average). “Closest” in this case may be defined by the Euclidean distance.

The differential rendering engine (310) is a software process configured to perform differential rendering to render a target object image from a target object model. The target object is the object that is the target of performing the differential rendering operation. The target object image is a virtual camera image that simulates an actual camera captured from a particular viewing direction, angle, and location of the virtual camera with regards to the target camera. Differential rendering is an iterative process that renders a target object image, compares the target object image with an actual image, and updates the target object model based on the comparison. Thus, differential rendering engine (310) iteratively improves the target object model to match the real world.

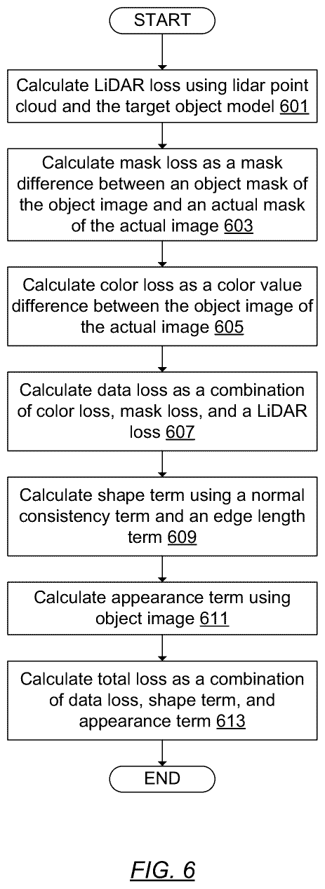

The differential rendering engine (310) is connected to a loss function (312) configured to calculate a loss based on the real sensor data (128) and simulated data. For example, the loss may include the differences between the LiDAR point cloud and the mesh being optimized. As another example, the loss may include the differences between the rendered target image and a corresponding actual image. In one or more embodiments, the differences are calculated based on one or more characteristics. Calculating the loss is described below with relation to FIG. 6. The differential rendering engine (310) updates the target object model according to the loss.

The parameterization engine (314) is configured to parameterize the decomposed model by generating and adding object parameters to the body component model (322), whereby the object parameters refer to the auxiliary component model (326). Specifically, for each auxiliary component model, the parameterization engine (314) is configured to scaling factors for matching the auxiliary component model to the body component model, the connection between the auxiliary component model and the body component model, and other parameters. The parameterization engine (314) is further configured to store the object parameters (324). Using the object parameters the complete target object model can be reconstructed and used by the differential rendering engine.

While FIGS. 1 and 3 show a configuration of components, other configurations may be used without departing from the scope of the invention. For example, various components may be combined to create a single component. As another example, the functionality performed by a single component may be performed by two or more components.

FIGS. 4-6 show flowcharts for generating an object model, training an object model, and performing differential rendering. While the various blocks in these flowcharts are presented and described sequentially, at least some of the blocks may be executed in different orders, may be combined or omitted, and at least some of the steps may be executed in parallel. Furthermore, the blocks may be performed actively or passively.

FIG. 4 shows a flowchart for generating a decomposed object model in accordance with one or more embodiments. Turning to FIG. 4, in Block 402, an annotated CAD model is obtained. In one or more embodiments, the annotated CAD model may be obtained from the data repository. Generating the annotated CAD model may be performed by a user interface interacting with a user. For example, the user interface may display the CAD model upon selection of the CAD model from the CAD library. The user interface receives a selection from user of a portion of the CAD model that corresponds to an auxiliary component or to the body component. For example, the selection may be mouse clicks on vertices or faces of the CAD model. The user may then label the selected portion with a label identifying the component matching the selected portion. For example, the label may identify the auxiliary component model corresponding to the CAD model. As another example, the label may be a unique identifier of the type of auxiliary component. In one or more embodiments, less than ten percent of the CAD models in the library are labeled by a user.

In Block 404, the library CAD model for the target object is obtained. The target object is an object that is the target of training. In some embodiments, the system iterates through the CAD models in the CAD library and trains the CAD models as described below. In some embodiments, a scenario is created and the CAD models in the CAD library corresponding to the scenario are identified. The rendering system may then train only the identified CAD models that have not yet been trained. Regardless of how a library CAD model is selected, the selected library CAD model is automatically annotated as described below.

In Block 406, the CAD transformer engine, deforms that annotated CAD model to match the library CAD model and generate a deformed annotated CAD model. In order to learn a low dimension code over a variety of objects, the templates from different CAD models and establish a one-to-one dense correspondence among the vertices of the mesh. The original CAD models are unaligned, as the original CAD models have a varying number of vertices, and the vertex ordering differs across models. In one or more embodiments, a single template mesh Msrc (i.e., the mesh of the annotated CAD model) is selected as the source mesh. One or more embodiments deform the vertices V of the single template mesh such that the vertices fit other meshes well. One or more embodiments exploit the vertices of the simplified target mesh (denoted as Pcad) and minimize the following energy: Ealign(V,Pcad)=Echamfer(V,Pcad)+λshape·Eshape(Msrc). Echamfer refers to the asymmetric Chamfer distance, and Eshape is the same as described below.

The CAD transformer engine may use features of the vertices and faces from the layers of the library CAD model and the annotated CAD model to move the vertices of the annotated CAD model. For example, vertices that are within a threshold difference of material shininess may indicate that both vertices below to a same component of an object. Other features may include curvature and other measures. As the annotated CAD model is deformed, the annotated regions keep the annotations. For example, the vertices and or faces that are in an annotated region remain annotated with the label while vertices and faces outside of the annotated region remain not having the label. When the annotated CAD model matches the geometry of the library CAD model, the flow proceeds to Block 408.

In Block 408, the library CAD model is annotated with the deformed annotated CAD model to generate an annotated library model. The parameterization engine automatically identifies the boundaries of an annotated region of the deformed annotated CAD model, and determines the matching region, based on position, in the library CAD model. Identifying the matching region is based on an overlay of the two models. The matching region in the library CAD model is labeled with the same label as the corresponding region in the deformed annotated CAD model. The process is repeated for each annotated region. The result is an annotated library model. Namely, the annotated library model is the library CAD model with the various regions automatically annotated.

In Block 410, the parameterization engine generates a decomposed object model from the annotated library model. Portions of the annotated library model that are annotated with an auxiliary component label are identified. An auxiliary component model matching the auxiliary component is determined from the label. If an auxiliary component model does not already exist, then the auxiliary component model is generated from the annotated library model. Specifically, the portion corresponding to the auxiliary component in the annotated library model is stored as a separate model and associated with a label. To reduce storage requirements, the number of vertices and the topology may be reduced.

Regardless of whether an auxiliary component model is stored, the identifiers of the connection vertices that correspond to a boundary between the auxiliary component and another component are identified and used to generate an object parameter defining the location of the auxiliary component in the object model. Further, the amount of scaling and rotation needed to align the auxiliary component model with the annotated region corresponding to the auxiliary component is determined and stored as scaling and rotation object parameters. The various object parameters are associated with an identifier of the auxiliary component model and stored in the body component model of the decomposed object model. The portion of the annotated library model annotated with the auxiliary component label is removed once the object parameters for the portion is stored. The process is repeated for each annotated portion that is not a body component. Each annotated portion corresponds to a set of object parameters for that portion. Thus, multiple sets of object parameters may be stored with the same body component model. The object parameters are stored in the body component model.

In Block 412, the decomposed object model is stored. In one or more embodiments, storing the decomposed object model stores the body component model with the annotated parameters in the data repository. The auxiliary component model may already be stored and shared across multiple decomposed object models.

Because the decomposed object model is from the CAD library, the decomposed object model may have some errors that cause the decomposed object model to not match the real world. Namely, the CAD objects, and correspondingly the decomposed object model, may be an idealized view of the target object or may have certain features that were not in the real world object during production of the real world object. For example, the decomposed object model may have incorrect light effects, may have errors in geometry. As discussed above, one or more embodiments may use the object models to train a virtual driver. In order to accurately train the virtual driver, virtual sensor input to the virtual driver during training should accurately reflect the real sensor input that would be received by the corresponding real sensors in the real world.

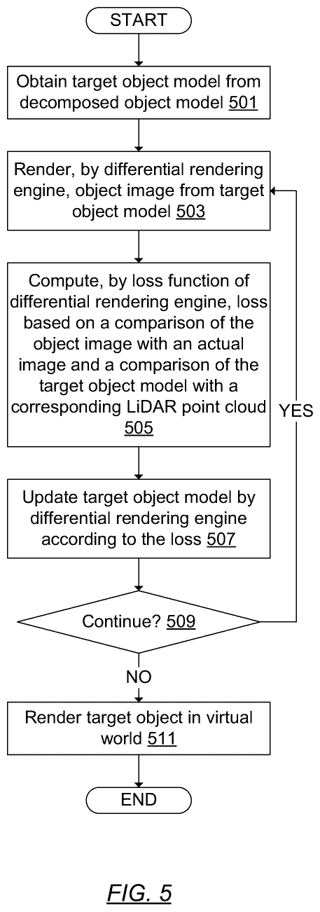

Thus, training is performed to match the virtual sensor input to the real sensor input. The training uses a variety of real camera images and real LiDAR point clouds captured at various stages of time of the target object to determine whether the target object model can be used to generate a virtual sensor input matching the real sensor input. If not, the target object model is updated. FIG. 5 shows a flowchart for training an object model in accordance with one or more embodiments.

Turning to FIG. 5, in Block 501, a target object model is obtained from the decomposed object model. Obtaining the target object model is performed in reverse of the parameterization. For example, the body component model for the target object model is obtained and the one or more sets of object parameters from the body component model. Based on an auxiliary component identifier in a set of object parameters, the auxiliary component model is identified. Using the set of object parameters, scaling and rotation is applied to the auxiliary component model, and then the auxiliary component model is added to the body component model at the location specified in the set of object parameters. The process is repeated for each set of object parameters to generate the target object model.

In Block 503, the differential rendering engine renders the object image from the target object model. Rendering is a process that uses the viewing direction and angle of a virtual camera to determine how light would interact with the object and the camera. Various existing rendering engines may be used, such as an OpenGL based rasterization engine.

In Block 505, a loss function of the differential rendering engine computes a loss based on a comparison of the object image with an actual image and a comparison of the target object model with a corresponding LiDAR point cloud. To compare the images, the color, shape and other properties of various locations in the object image are compared against the color, shape, and other properties of the various locations in the real camera image (i.e., the actual image). Differences between the properties are added to the loss value. The LiDAR point cloud has point values in three dimensional space. The LiDAR point cloud may be filtered to remove points that do not correspond to the target object. A determination of points that are in the LiDAR point cloud and correctly on the surface of the target object model versus the points that are not on the surface of the target object model is used to calculate the LiDAR loss. The combination of various losses may be used as a combined loss.

In Block 507, the target object model is updated by the differential rendering engine according to the loss. The target object model may be updated by updating the mesh, the projection matrix, material and lighting maps, and other parts of the target object model.

In Block 509, a determination is made whether to continue. The determination is made to continue if more real images exist, if convergence of the target object model is not achieved, and/or if the solution is stable. If the determination is to continue, the flow returns to Block 503. If the determination is made not to continue, the flow proceeds to Block 511.

In Block 511, the target object is rendered in a virtual world. A scenario is defined as described above that includes the target object. The target object model is used to render the target object according to the viewing direction, orientation, and other aspects of the scenario. The rendering may be performed as discussed above by a rendering engine that is configured to render images from mesh networks. Thus, the trained target object model may be used to create a virtual world that replicates a real world, but with new or modified scenarios not existing in the real world. Through the training, the simulated sensor data generated from the target object model more accurately matches with real world sensor data.

FIG. 6 shows a flowchart for calculating loss in accordance with one or more embodiments. In the discussion below, the following notation may be used. I={Iᵢ}_{1≤i≤N} is the images captured at different timestamps and [symbol] is the aggregated LiDAR point clouds captured by a data collection platform (e.g., a self-driving vehicle driving in the real world). {Mᵢ}_{1≤i≤N} is the foreground segmentation mask of {Iᵢ}_{1≤i≤N}. [symbol] {D, R} are the variables directly related to the appearance model (i.e., material and lighting). Π=(Kᵢ^{cam}, ξᵢ^{cam}, ξᵢ) is the intrinsics and extrinsics of the sensors, where ξ∈se (3) is the Lie-algebra associated with SE(3). The cameras are assumed to be pre-calibrated with known intrinsics. Further, Ψ: ( [symbol] , [symbol] , Π)→(I_{Ψ}, M_{Ψ}) is the differential renderer engine with I_{Ψ} and M_{Ψ} denoting the rendered color object image (e.g., in RGB format) and object mask.

In Block 601, LiDAR loss is calculated using the LiDAR point cloud and the target object model. To calculated LiDAR loss, a lidar energy term E_{LiDAR} may be calculated using equation (1) below. In equation (1), E_{LiDAR} encourages the geometry of the mesh to match the aggregated LiDAR point clouds. Because minimizing point-to-surface distance is computationally expensive in practice, one or more embodiments may use Chamfer Distance (denoted as “CD” in equation (1)) to measure the similarity. L points ( [symbol] ₛ) may be randomly selected from the current target object mesh. The asymmetric CD of [symbol] ₛ may be computed with respect to the aggregated point cloud [symbol] . In equation (1), α is an indicator function representing which LiDAR point value is an outlier. The indicator function α may be estimated by calculating the CD for the top percentage of point pairs. In equation (1), [symbol] ₛ˜ [symbol] and | [symbol] |=L.

$$\\ \begin{matrix}{E}_{Lidar} = CD ( {}_{s} , ) = \frac{1}{\vert {s}_{} \vert} {\sum }_{x ∈ {𝒫}_{s}} {α}_{x} {min}_{y ∈ 𝒫} {‖ x - y ‖}_{2}^{2} & ( 1 )\end{matrix}$$

In Block 603, mask loss is calculated as a mask difference between an object mask of the object image and an actual mask of an actual image. A segmentation model is executed on the real camera image to generate an object mask for the real world. For example, the segmentation model may be a convolutional neural network trained to label pixels of an image as the type of the target object or not belonging to the type corresponding to the target object. The result of executing the segmentation model is an object mask for the real camera image. For the object image generated from the target object model, an object mask is created that specifies, for each location in the object image, whether the location is part of the target object. The difference between the object masks generated from the real camera image and the object mask generated from the object image is the mask loss. The mask loss may be calculated using equation (2) below. In equation (2), Nis the number of images available, a squared [symbol] ₂ distance may be used for object mask,

$$\\ \begin{matrix}{E}_{mask} = \frac{1}{N} {\sum }_{i = 1}^{N} {‖ {M}_{Ψ} ( , {K}_{i} , {ξ}_{1} ) - {M}_{s} ‖}_{2}^{2} & ( 2 )\end{matrix}$$

Let ψ: (M, A, Π)→(I_{ψ},M_{ψ}) is the differentiable renderer where I_{ψ} and M_{ψ} denote the rendered RGB image and object mask. Ki and ξi are the intrinsics and extrinsics for the cameras, respectively. [symbol] is the mesh, Mₛ is the segmented mask from an off-the-shelf segmentation model.

In Block 605, color loss is calculated as a color value difference between the object image and the actual image for the target object. The color loss may be calculated using the color energy equation of equation (3) below. The color loss encourages the appearance of the target object image to match the red-green-blue (RGB) values from the real world camera image and propagates the gradients to the variables including the appearance variables [symbol] . A smooth- [symbol] ₁ distance is used to measure the difference in RGB space. Equation may be

$$\\ \begin{matrix}{E}_{color} = \frac{1}{N} {\sum }_{i = 1}^{N} {\overline{ℓ}}_{i} ( {I}_{Ψ} ( , {K}_{i} , {ξ}_{i} , {}_{i} ) , {I}_{i} ) & ( 3 )\end{matrix}$$

In Block 607, data loss is calculated as a combination of the color loss, mask loss, and the LiDAR loss. The data loss is calculated as a data energy term that encourages the estimated textured mesh to match the sensor data as much as possible. The data loss is a combination of color loss, mask loss, and lidar loss using equation (4) below. In equation (4), λ_{Mask} is a mask weight and λ_{Lidar} is a lidar weight.

$$\\ \begin{matrix}{E}_{data} ( , Π , ; , ) = {E}_{color} ( , Π , ; ) + {λ}_{Mask} {E}_{Mask} ( , Π ; ) + {λ}_{Lidar} {E}_{Lidar} ( , Π ; ) & ( 4 )\end{matrix}$$

In Block 609, a shape term is calculated using a normal consistency term and an edge length term. The shape term encourages the deformed mesh to be smooth and the faces of the mesh to be uniformly distributed among the surfaces (so that the appearance would be less likely distorted). The shape term may be calculated as the sum of the normal consistency term (E_{Normal}) and the edge consistency term (E_{Edge}). the normal consistency term may be calculated using equation (5) and the edge consistency term may be calculated using equation (6). In both equation (5) and equation (6), the vertices v are each the set of vertices V of the Mesh while the faces f is in the set of faces F) of the Mesh. In equation (5) and equation (6), N_{F} and N_{E} are the number of neighboring faces and edges, respectively; [symbol] (f) and [symbol] (v) is set of neighboring faces of a single face f and the neighboring vertices of a single vertex v; and n(f) and n(v) are the number of neighboring faces of a single face f and the neighboring vertices of a single vertex v, respectively.

$$\\ \begin{matrix}{E}_{Normal} ( V ) = \frac{1}{{N}_{F}} {\sum }_{f ∈ F} {\sum }_{{f}^{′} ∈ 𝒩 ( f )} {‖ n ( f ) \cdot n ( {f}^{′} ) ‖}_{2}^{2} & ( 5 )\end{matrix}$$

$$\\ \begin{matrix}{E}_{edge} ( V ) = \frac{1}{{N}_{E}} {\sum }_{v ∈ V} {\sum }_{{v}^{′} ∈ 𝒩 ( v )} {‖ v - {v}^{′} ‖}_{2}^{2} & ( 6 )\end{matrix}$$

In Block 611, an appearance term is calculated using the object image. The appearance term may be calculated using equation (7). For vehicles, the appearance term exploits the facts that the appearance of a vehicle will not change abruptly and, rather, varies in a smooth fashion, and that the real world is dominated by neutral, white lighting. Thus, a sparsity term may be used as shown in equation (7) to penalize frequent color changes on the diffuse k_{d} and specular kₛ terms. A regularizer term (i.e., ∥cᵢ−c̅ᵢ∥₁) is added to penalize the environment light in gray scale. In equation 7, ∇k_{d} and ∇kₛ are image gradients that may be approximated by Sobel-Feldman operator. Further, cᵢ and c̅ᵢ are the light intensity values at RGB channels and the per channel average intensities, respectively. λ_{light} is a lighting weight value.

Eₐₚₚ=λₘₐₜ(|∇k_{d}∥₁+|∇kₛ|₁)+λ_{light}Σᵢ₌₁³∥cᵢ−c̅ᵢ∥₁ (7)

In Block 613, the total loss is calculated as a combination of data loss, shape term, and appearance term. The total loss is calculated using an energy function with complementary terms which measure the geometry and appearance agreement between the observations and estimations (E_{data}), while regularizing the shape (Eₛₕₐₚₑ) and appearance (Eₐₚₚ) to obey known priors. The total loss may be calculated using equation (8) and the above equations. In equation 8, λₛₕₐₚₑ is a weight on the shape term and λₐₚₚ is a weight on the appearance term.

$$\{ \begin{matrix}{E}_{data} ( , Π , ; , ) + {λ}_{shape} \cdot {E}_{shape} ( ) + \\ {λ}_{app} \cdot {E}_{app} ( , Π , ; , )\end{matrix} \} \qquad ( 8 )$$

The operations of FIG. 5 and FIG. 6 is to generate a target object model that accurately represents the real world. In one or more embodiments, the target object model is a low dimensional model that has fewer vertices than the initial CAD model. The initial model may be an initial coarse mesh [symbol] ᵢₙᵢₜ=(Vᵢₙᵢₜ,F), where Vᵢₙᵢₜ is reconstructed from the optimized latent code z* calculated using equation (9) below.

$$\\ \begin{matrix}z * = {arg min}_{z} ( {λ}_{mask} {E}_{mask} ( , Π ; ) + {λ}_{LiDAR} \cdot {E}_{LiDAR} ( , Π ; ) + {λ}_{shape} \cdot {E}_{shape} ( V ) & ( 9 )\end{matrix}$$

The latent code is initialized from the 0 vector, and the sensor poses are obtained from coarse calibration and fixed. One or more embodiments optimize z using stochastic gradient descent with the Adam optimizer.

The updating may be performed as follows. Given the initialization, [symbol] ᵢₙᵢₜ, The vertices V, appearance variables [symbol] , and sensor poses [symbol] are jointly optimized using equation (8). To reduce processing requirements, one or more embodiment uniformly sample L points on the current mesh at each iteration to compute the LiDAR energy E_{LiDAR} as discussed above.

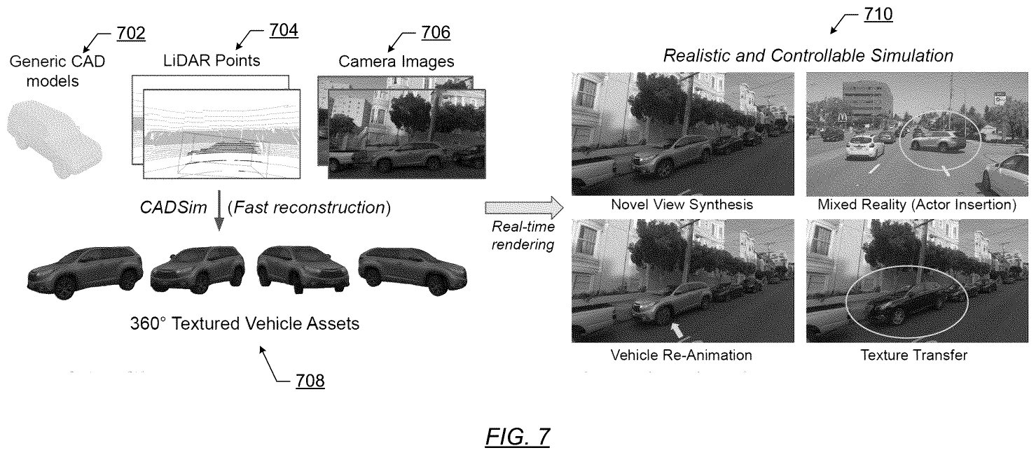

FIGS. 7-9 present examples in accordance with one or more embodiments. The various examples are for explanatory purposes only. Embodiments are not limited to the examples described below unless expressly claimed. One or more embodiments are directed to using realistic simulation enables safe and scalable development of self-driving vehicles. A core component is simulating the sensors so that the entire autonomy system can be tested in simulation. Sensor simulation involves modeling traffic participants, such as vehicles, with high quality appearance and articulated geometry, and rendering the traffic participants in real time. Reconstructing assets automatically from sensor data collected in the real world provides a better path to generating a diverse and large set with good real-world coverage. Nevertheless, current reconstruction approaches struggle using real world sensor data, due to the sparsity and noise of the real world sensor data. One or more embodiments, use part-aware object-class priors via a small set of CAD models with differentiable rendering to automatically reconstruct vehicle geometry, including articulated wheels, with high-quality appearance. Thus, in one or more embodiments, more accurate shapes from sparse data are obtained compared to existing approaches. Further one or more embodiments, trains and renders target objects efficiently to provide accurate testing and training of virtual drivers.

FIG. 7 shows an example diagram for virtual simulation in accordance with one or more embodiments. Specifically, FIG. 7 shows an overview of one or more embodiments in use. As shown in FIG. 7, generic CAD models (702) are used in conjunction with real world sensor data, including LiDAR points (704) and camera images (706), by CADSim (i.e., the rendering system described above and shown in FIG. 3) to generate 360 degree representation of textured vehicle assets (708) (i.e., target object models described above). After generating the 360 degree representation of textured vehicle asset (708), the representation of the asset may be used for real-time rendering of new scenes (710). For example, the scenes that are rendered may include new view synthesis, mixed reality whereby an instance of the asset is inserted in the scene, animation of the asset, or changing the texture of the asset from a different vehicle.

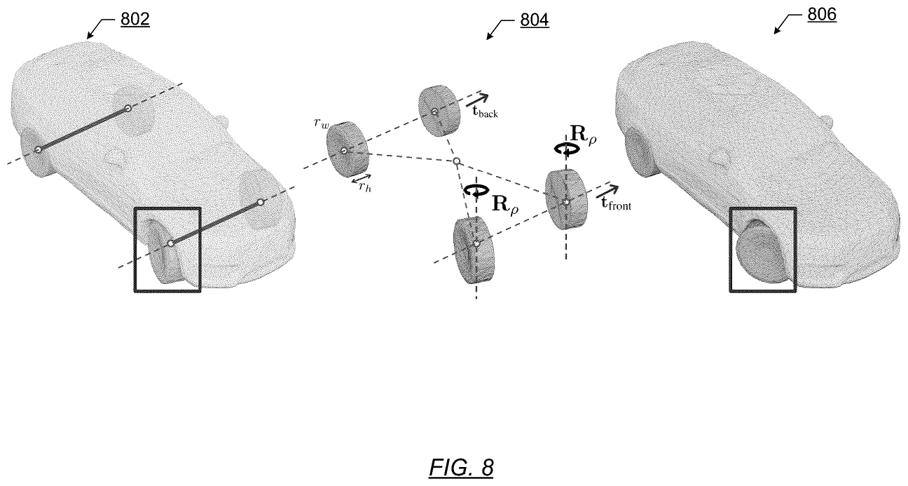

FIG. 8 shows an example diagram showing a decomposed object model in accordance with one or more embodiments. As shown in FIG. 8, the target object model (802) is a car having four tires. The decomposed object model separates the model of the tires (804) from the model of the body of the car (806). The car tires are modeled separately. Specifically, a mesh M=(V, F) is composed of a set of vertices V∈R|V^{|×3} and faces F∈N^{|F|×3}, where the faces define the connectivity of the vertices. The goal is deforming a mesh to match the observations from the sensor data. Generally, during deformation, the topology (i.e., connectivity) of the mesh is fixed and only the vertices are “moving”. This strategy greatly simplifies the deformation process, yet at the same time constrains its representation power. For instance, if the initial mesh topology is relatively simple and non-homeomorphic to the object of interest, the mesh may struggle to capture the fine-grained geometry (e.g., side mirrors of a car). To circumvent such limitations, one or more embodiments incorporate shape priors from CAD models into the mesh reconstruction. One straightforward approach is to directly exploit the CAD model to initialize the mesh. Since CAD models, by design, respect the topology of real-world objects, the mesh will be able to model finer details. However, there is no structure among the vertices. Each vertex may move freely in the 3D space during the optimization Thus, there is no guarantee that vertices belonging to a wheel will continue to form a cylinder. To address this challenge, the part information from CAD models may be incorporated into the parameterization.

Semantic part information from CAD models may be used to partition the vehicle mesh into a vehicle body and tires as shown in FIG. 8. Thus, the full vehicle mesh model can be written as:

V_{wheel}^{k}(r,t_{front},ρ;V_{wheel})=T^{k}(R_{ρ}rV_{wheel}+t_{front}) for front tires

V_{wheel}^{k}(r,t_{back};V_{wheel})=T^{k}(rV_{wheel}+t_{back}) for remaining tires

V={T^{k}(V_{body},V_{wheel}^{(k)})

In the above model, the wheels may each have the same underlying mesh (V_{wheel},F_{wheel}). The parameterization further stores object parameters for the individual respective pose T^{k}, and a scale factor r on the wheel radius and thickness. their individual relative pose T^{k} to the vehicle origin. As there are a wide variety of vehicles with different wheel sizes and different relative positions to the vehicle body, we further add a scale factor r=[rw, rh, rw] (wheel radius and thickness), and per-axle translation offsets t_{front}, t_{back} with respect to the wheel origin. Because the front-axle wheels can be steered and do not necessarily align with the body, the front axle wheels may further be parameterized to have a yaw-relative orientation ρ.

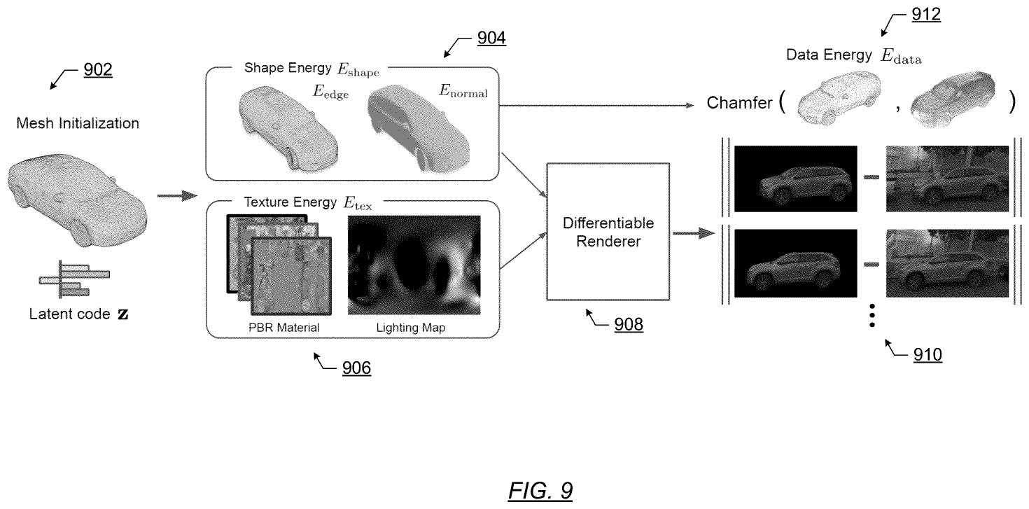

FIG. 9 shows an example diagram showing rendering system in accordance with one or more embodiments. As shown in FIG. 9, the mesh initialization (902) is used as input to calculate a shape energy term (904) and a texture energy term (906) that are used by the differential renderer (908) to render an images (910). The shape energy term may further be used to determine the Chamfer Distance (912). The images and the chamfer distance may further be used to update the vehicle model. Thus, the vehicle model more accurately represents the real world sensor data.

Although a portion of the description describes using object reconstruction of the target object as part of generating a simulated environment in order to train and test an autonomous system, the object reconstruction may be used in any generation of a virtual world. For example, one or more embodiments may reconstruct target objects as part of a gaming system to create mixed reality games for players to play. Object reconstruction for the various types of virtual worlds is contemplated herein without departing from the scope of the invention.

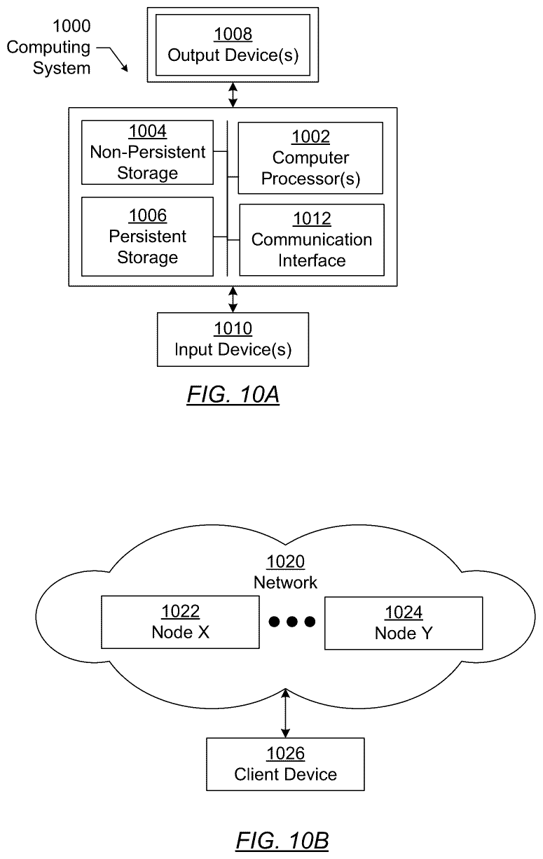

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 10A, the computing system (1000) may include one or more computer processors (1002), non-persistent storage (1004), persistent storage (1006), a communication interface (1008) (e.g., Bluetooth interface, infrared interface, network interface, optical interface, etc.), and numerous other elements and functionalities that implement the features and elements of the disclosure. The computer processor(s) (1002) may be an integrated circuit for processing instructions. The computer processor(s) may be one or more cores or micro-cores of a processor. The computer processor(s) (1002) includes one or more processors. The one or more processors may include a central processing unit (CPU), a graphics processing unit (GPU), a tensor processing units (TPU), combinations thereof, etc.

The input devices (1010) may include a touchscreen, keyboard, mouse, microphone, touchpad, electronic pen, or any other type of input device. The input devices (1010) may receive inputs from a user that are responsive to data and messages presented by the output devices (1012). The inputs may include text input, audio input, video input, etc., which may be processed and transmitted by the computing system (1000) in accordance with the disclosure. The communication interface (1008) may include an integrated circuit for connecting the computing system (1000) to a network (not shown) (e.g., a local area network (LAN), a wide area network (WAN) such as the Internet, mobile network, or any other type of network) and/or to another device, such as another computing device.

Further, the output devices (1012) may include a display device, a printer, external storage, or any other output device. One or more of the output devices may be the same or different from the input device(s). The input and output device(s) may be locally or remotely connected to the computer processor(s) (1002). Many different types of computing systems exist, and the aforementioned input and output device(s) may take other forms. The output devices (1012) may display data and messages that are transmitted and received by the computing system (1000). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (1000) in FIG. 10A may be connected to or be a part of a network. For example, as shown in FIG. 10B, the network (1020) may include multiple nodes (e.g., node X (1022), node Y (1024)). Each node may correspond to a computing system, such as the computing system shown in FIG. 10A, or a group of nodes combined may correspond to the computing system shown in FIG. 10A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1000) may be located at a remote location and connected to the other elements over a network.

The nodes (e.g., node X (1022), node Y (1024)) in the network (1020) may be configured to provide services for a client device (1026), including receiving requests and transmitting responses to the client device (1026). For example, the nodes may be part of a cloud computing system. The client device (1026) may be a computing system, such as the computing system shown in FIG. 10A. Further, the client device (1026) may include and/or perform all or a portion of one or more embodiments.

The computing system of FIG. 10A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
rendering, by a differential rendering engine, an object image from a target object model;
computing, by a loss function of the differential rendering engine, a loss based on a comparison of the object image with an actual image and a comparison of the target object model with a corresponding lidar point cloud;
updating the target object model by the differential rendering engine according to the loss; and
rendering, after updating the target object model, a target object in a virtual world using the target object model.

2. The method of claim 1, further comprising:
obtaining an annotated CAD model;
obtaining a library CAD model for a target object;
deforming, by a CAD transformer engine, the annotated CAD model to match the library CAD model to generate a deformed annotated CAD model; and
annotating the library CAD model with an annotation from the deformed annotated CAD model to generate an annotated library model,
wherein the target object model is generated from the annotated library model.

3. The method of claim 2, further comprising:
generating, with a parameterization engine, a decomposed object model from the annotated library model; and
storing the decomposed object model.

4. The method of claim 3, wherein:
the decomposed object model comprises:
a first component model for a first component of the target object, and
a second component model for a second component of the target object,
the first component model and the second component model are individual and separate models, and
the first component model comprises a set of parameters detailing a connection between the first component model and the second component model.

5. The method of claim 3, further comprising:
generating an object model from the decomposed object model, the decomposed object model comprising:
a first component model for a first component of the target object, and
a second component model for a second component of the target object,
wherein the first component model and the second component model are individual and separate models, and
wherein the first component model comprises a set of parameters detailing a connection between the first component model and the second component model.

6. The method of claim 5, wherein the second component model is generic to a plurality of objects, and the set of object parameters comprises a location parameter detailing a placement of a second component in the first component and a scaling parameters detailing a scaling factor for the second component to fit the first component.

7. The method of claim 1, further comprising:
calculating a loss as a combination of a data loss, a shape term, and an appearance term.

8. The method of claim 7, further comprising:
calculating a color loss using the object image and the actual image;
calculating a LiDAR loss using a LiDAR point cloud and the target object model;
calculating a mask loss as a mask difference between an object mask of the object image and an actual mask of the actual image; and
calculating the data loss as a combination of the color loss, the LiDAR loss, and the mask loss.

9. The method of claim 7, further comprising:
calculating the shape term using a normal consistency term and an edge length term.

10. The method of claim 7, further comprising:
calculating the appearance term using the object image.

11. The method of claim 1,
obtaining a first CAD model;
obtaining a library CAD model for a target object; and
deforming, by a CAD transformer engine, the first CAD model to match the library CAD model to generate a deformed model,
wherein the target object model is generated from the library CAD model, and
wherein rendering the target object in the virtual world comprises transferring a texture from the deformed model.

12. A system comprising:
memory; and
at least one processor configured to execute instructions to perform operations comprising:
rendering, by a differential rendering engine, an object image from a target object model;
computing, by a loss function of the differential rendering engine, a loss based on a comparison of the object image with an actual image and a comparison of the target object model with a corresponding lidar point cloud;
updating the target object model by the differential rendering engine according to the loss; and
rendering, after updating the target object model, a target object in a virtual world using the target object model.

13. The system of claim 12, wherein the operations further comprise:
obtaining an annotated CAD model;
obtaining a library CAD model for a target object;
deforming, by a CAD transformer engine, the annotated CAD model to match the library CAD model to generate a deformed annotated CAD model; and
annotating the library CAD model with an annotation from the deformed annotated CAD model to generate an annotated library model,
wherein the target object model is generated from the annotated library model.

14. The system of claim 13, wherein the operations further comprise:
generating, with a parameterization engine, a decomposed object model from the annotated library model; and
store the decomposed object model.

15. The system of claim 14, wherein:
the decomposed object model comprises:
a first component model for a first component of the target object, and
a second component model for a second component of the target object,
the first component model and the second component model are individual and separate models, and
the first component model comprises a set of parameters detailing a connection between the first component model and the second component model.

16. The system of claim 14, wherein the operations further comprise:
generating an object model from the decomposed object model, the decomposed object model comprising:
a first component model for a first component of the target object, and
a second component model for a second component of the target object,
wherein the first component model and the second component model are individual and separate models, and
wherein the first component model comprises a set of parameters detailing a connection between the first component model and the second component model.

17. The system of claim 12, wherein the operations further comprise:
calculating a loss as a combination of a data loss, a shape term, and an appearance term.

18. The system of claim 17, wherein the operations further comprise:
calculating a color loss using the object image and the actual image;
calculating a LiDAR loss using a LiDAR point cloud and the target object model;
calculating a mask loss as a mask difference between an object mask of the object image and an actual mask of the actual image; and
calculating the data loss as a combination of the color loss, the LiDAR loss, and the mask loss.

19. A non-transitory computer readable medium comprising computer readable program code for causing a computing system to perform operations comprising:
rendering, by a differential rendering engine, an object image from a target object model;
computing, by a loss function of the differential rendering engine, a loss based on a comparison of the object image with an actual image and a comparison of the target object model with a corresponding lidar point cloud;
updating the target object model by the differential rendering engine according to the loss; and
rendering, after updating the target object model, a target object in a virtual world using the target object model.

20. The non-transitory computer readable medium of claim 19, further comprising:
obtaining an annotated CAD model;
obtaining a library CAD model for a target object;
deforming, by a CAD transformer engine, the annotated CAD model to match the library CAD model to generate a deformed annotated CAD model; and
annotating the library CAD model with an annotation from the deformed annotated CAD model to generate an annotated library model,
wherein the target object model is generated from the annotated library model.
